(19) United States
(12) Patent Application Publication
(10) Pub. No.: US 2016/0103536 A1
(43) Pub. Date: Apr. 14, 2016

(54) TOUCH PANEL, MANUFACTURING METHOD THEREOF AND DISPLAY DEVICE

(71) Applicants: Shanghai Tianma AM-OLED Co., Ltd., Shanghai (CN); Tianma Micro-Electronics Co., Ltd., Shenzhen (CN)

(72) Inventors: Zhiyong Xiong, Shanghai (CN); Qijun Yao, Shanghai (CN); Dong Qian, Shanghai (CN)

(21) Appl. No.: 14/638,184

(22) Filed: Mar. 4, 2015

(30) Foreign Application Priority Data
Oct. 13, 2014 (CN) 201410538192.1

(51) Int. Cl. G06F 3/041; G09G 3/32

(52) U.S. Cl. CPC G06F 3/0412; G09G 3/3225; G06F 2203/04103

(57) ABSTRACT

A touch panel, a manufacturing method thereof and a display device are disclosed by the present disclosure, where the touch panel includes: a first substrate and a second substrate disposed opposite to each other; an organic light emitting layer located between the first substrate and the second substrate; where the organic light emitting layer includes at least a cathodic layer formed by a plurality of strip-shaped cathodic electrodes; and a first touch layer including a plurality of first touch electrodes, each of which includes at least one first touch sub-electrode, a projection of which on the organic light emitting layer is located between two adjacent cathodic electrodes. Technical solutions of the present disclosure can at least reduce electromagnetic interference between the first touch layer and the cathodic electrode, so that display effect and touch control effect may be improved; in addition, manufacturing processes and production cost may be reduced.

### CROSS-REFERENCE TO RELATED APPLICATION

This application claims priority to Chinese Patent Application No. 201410538192.1, filed Oct. 13, 2014, which is herein incorporated by reference in its entirety.

### TECHNICAL FIELD

The present disclosure relates to the field of display technologies, and particularly to a touch panel, a manufacturing method thereof and a display device.

### BACKGROUND

An Active Matrix Organic Light Emitting Diode (AMOLED) possesses characteristics such as self-illumination, low consumption, fast response, high contrast and wide viewing angle. Therefore, the AMOLED has a wide application prospect in the field of display technologies.

With development of display technologies, a touch structure is integrated in an AMOLED display panel to achieve a touch control function. In the related art, the touch structure is typically integrated in the AMOLED display panel in an On-Cell manner in order for the touch control function of the AMOLED display panel. However, in such AMOLED display panels with the touch structure integrated in the On-Cell manner, electromagnetic interference occurs between the touch structure and a display structure during operation of the AMOLED display panel, and hence a display effect and a touch control effect of the AMOLED display panel are affected; moreover, the above integration by the On-Cell manner includes lots of manufacturing processes and results in a high production cost.

### SUMMARY

In view of the above, embodiments of the present disclosure provide a touch panel, a manufacturing method thereof and a display device to avoid the electromagnetic interference between a touch structure and a display structure, the lots of manufacturing processes and the high production cost of the AMOLED display panel having a touch control function integrated in the On-Cell manner of the related art.

In a first aspect, embodiments of the present disclosure provide a touch panel, including:
a first substrate and a second substrate disposed opposite to each other;
an organic light emitting layer located between the first substrate and the second substrate; where the organic light emitting layer includes at least a cathodic layer formed by a plurality of strip-shaped cathodic electrodes; and
a first touch layer, which is located between the first substrate and the second substrate and includes a plurality of first touch electrodes, each of the first touch electrodes includes at least one first touch sub-electrode, a projection of the first touch sub-electrode on the organic light emitting layer is located between two adjacent cathodic electrodes.

In a second aspect, embodiments of the present disclosure further provide a display device, including the touch panel described in the above first aspect.

In a third aspect, embodiment of the present disclosure further provide a manufacturing method of a touch panel, including:
forming an organic light emitting layer on a second substrate, where the organic light emitting layer includes at least a cathodic layer formed by a plurality of strip-shaped cathodic electrodes; and
forming, on the second substrate, a first touch layer including a plurality of first touch electrodes; where the first touch electrode includes at least one first touch sub-electrode, a projection of the first touch sub-electrode on the organic light emitting layer is located between two adjacent cathodic electrodes.

As for the touch panel, manufacturing method thereof and display device provided by embodiments of the present disclosure, by at least disposing the first touch layer achieving touch control function between the first substrate and the second substrate, disposing the cathodic electrode into a strip shape, and disposing the projection, on the organic light emitting layer, of the first touch sub-electrode on the first touch layer between two adjacent cathodic electrodes, at least electromagnetic interference between the first touch layer and the cathodic electrode can be reduced, so that display effect and touch control effect may be improved. In addition, the first touch layer and the organic light emitting layer may be formed by an evaporation process since the organic light emitting layer is also disposed between the first substrate and the second substrate, thus reducing not only manufacturing processes but also production cost.

While multiple embodiments are disclosed, still other embodiments of the present disclosure will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

Features, objects and advantages of the present disclosure will become apparent by the detailed description of non-restrictive embodiments made by referring to the accompanying drawings listed below.

FIG. 1A is a schematic diagram showing the structure of an AMOLED display panel in the related art;

FIG. 1B is a top view of a touch structure on a first substrate in FIG. 1A;

FIG. 1C is a schematic cross-sectional diagram of the touch structure in FIG. 1B taken along a direction of Al -A2;

FIG. 1D is another schematic cross-sectional diagram of the touch structure in FIG. 1B taken along a direction of Al-A2;

FIG. 2 is a schematic diagram showing the structure of a touch panel, according to embodiments of the present disclosure;

FIG. 3A is a schematic diagram showing the structure of another touch panel, according to embodiments of the present disclosure;

FIG. 3B is a top view of a second touch layer in FIG. 3A;

FIG. 3C is a top view of another second touch layer in FIG. 3A;

FIG. 3D is a schematic diagram showing the structure of a touch panel, according to embodiments of the present disclosure;

FIG. 3E is a schematic diagram showing the structure of another touch panel, according to embodiments of the present disclosure;

FIG. 3F is a schematic diagram showing the structure of another touch panel, according to embodiments of the present disclosure;

FIG. 4A is a schematic diagram showing the structure of another touch panel, according to embodiments of the present disclosure;

FIG. 4B is a top view showing a first touch layer, a second touch layer and an organic light emitting layer in FIG. 4A;

FIG. 4C is a schematic diagram showing the structure of another touch panel, according to embodiments of the present disclosure;

FIG. 4D is a top view of a first touch layer, a second touch layer and an organic light emitting layer in FIG. 4C;

FIG. 4E is a schematic diagram showing the structure of another touch panel, according to embodiments of the present disclosure;

FIG. 4F is a top view showing a first touch layer, a second touch layer and an organic light emitting layer in FIG. 4E;

FIG. 5A is a schematic diagram showing the structure of another touch panel, according to embodiments of the present disclosure;

FIG. 5B is a top view of a first touch layer, a second touch layer and an organic light emitting layer in FIG. 5A;

FIG. 5C is a schematic cross-sectional diagram of the first touch layer, the second touch layer and the organic light emitting layer in FIG. 5B taken along a direction of B1-B2;

FIG. 5D is a schematic diagram showing the structure of another touch panel, according to embodiments of the present disclosure;

FIG. 5E is a top view of a first touch layer, a second touch layer and an organic light emitting layer in FIG. 5D;

FIG. 5F is a schematic cross-sectional diagram of the first touch layer, the second touch layer and the organic light emitting layer in FIG. 5E taken along a direction of C1-C2;

FIG. 6A is a schematic flow diagram of a manufacturing method of a touch panel, according to embodiments of the present disclosure;

FIG. 6B is a schematic flow diagram of a manufacturing method of a second touch layer in a touch panel, according to embodiments of the present disclosure;

FIG. 6C is a schematic flow diagram of a manufacturing method of a second touch layer in another touch panel, according to embodiments of the present disclosure; and

FIG. 7 is a schematic diagram showing the structure of a display device, according to embodiments of the present disclosure.

While the embodiments described in the disclosure are amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the appended claims.

### DETAILED DESCRIPTION

The present disclosure is further described in detail below in combination with the accompany drawings and embodiments. It shall be understood that the specific embodiments described here are used for description in the present disclosure rather than for limiting the present disclosure in any way. It should be further noted that only parts of but not all content of the present disclosure are shown in the accompany drawings for the sake of description.

With development of display technologies, a touch structure is integrated in an AMOLED display panel to achieve a touch control function. In the related art, the touch structure is integrated in the AMOLED display panel in an On-Cell manner to implement the touch control function of the AMOLED display panel.

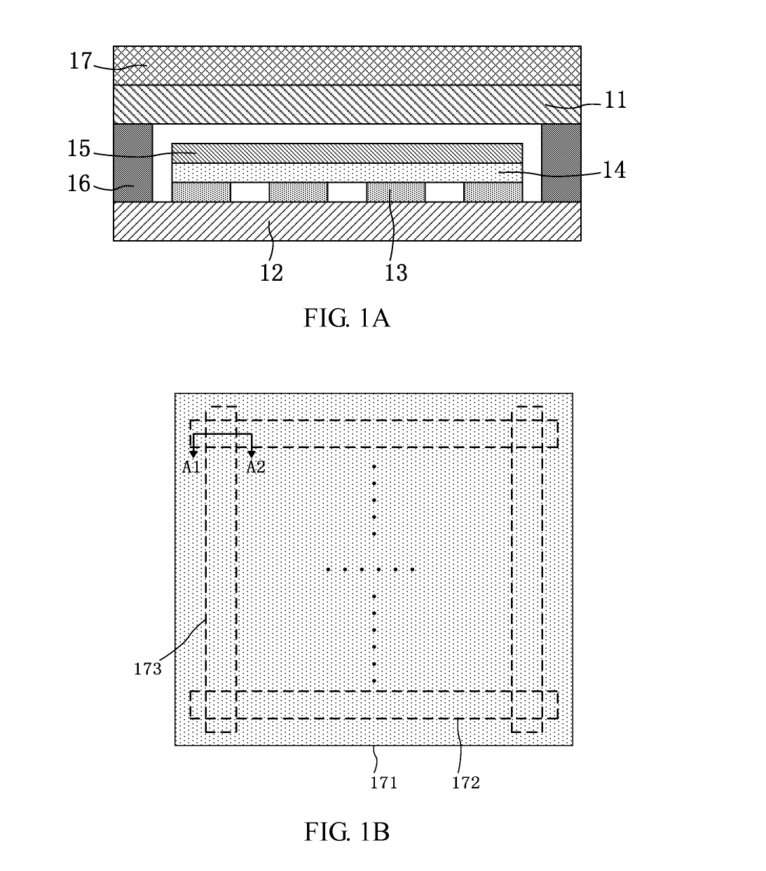

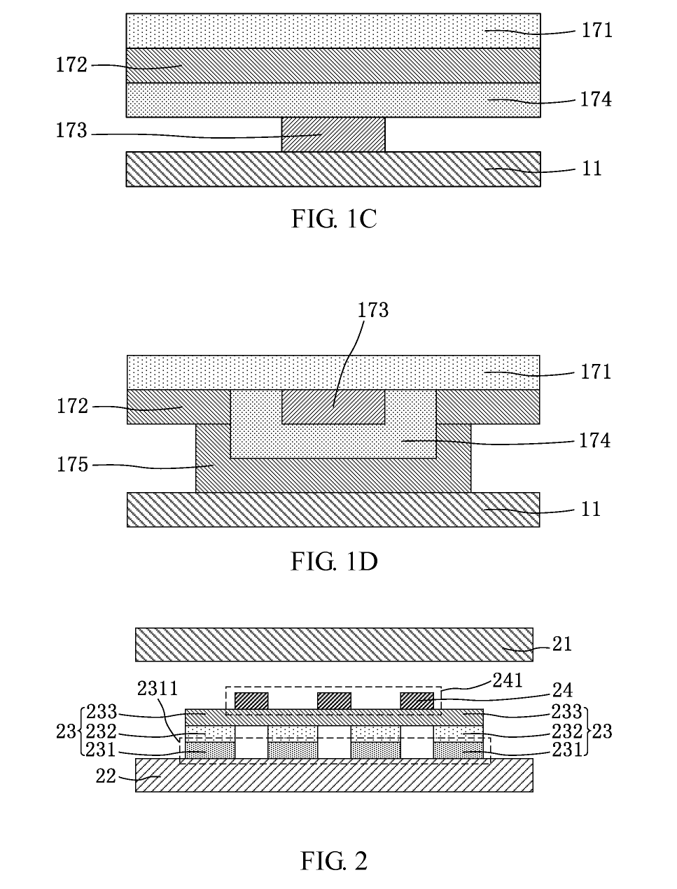

FIG. 1A is a schematic diagram showing the structure of an AMOLED display panel in the related art. As shown in FIG. 1A, the AMOLED display panel includes: a first substrate 11 and a second substrate 12 disposed opposite to each other; pixels 13, a cathode protection layer 14 and a planar cathodic electrode 15 disposed in sequence on the second substrate 12 between the first substrate 11 and the second substrate 12; and a touch structure 17 disposed on the first substrate 11, where the first substrate 11 and the second substrate 12 are adhered together by frame adhesives 16 and form an AMOLED display structure together with the pixels 13, the cathode protection layer 14 and the cathodic electrode 15 between the two first and second substrates. As shown in FIG. 1A, the touch structure 17 is integrated with the AMOLED display structure together in the On-Cell manner, and the touch structure 17 includes at least two touch layers which may be located on different layers or the same layer and are electrically insulated from each other.

FIG. 1B is a top view of a touch structure on the first substrate in FIG. 1A. As shown in FIG. 1B, the touch structure includes a first passivation layer 171, and a first touch layer formed by a plurality of first touch electrodes 172 and a second touch layer formed by a plurality of second touch electrodes 173 both below the first passivation layer 171, where the first touch electrodes 172 intersect the second touch electrodes 173 and are electrically insulated from the second touch electrodes 173.

The first touch electrodes 172 and the second touch electrodes 173 may be located on different layers, referring to FIG. 1C which shows a schematic cross-sectional diagram of the touch structure in FIG. 1B taken along a direction of A1-A2. As shown in FIG. 1C, the touch structure on the first substrate 11 includes, in sequence, a second touch layer formed by a plurality of second touch electrodes 173, a second passivation layer 174, a first touch layer formed by a plurality of first touch electrodes 172 and a first passivation layer 171. The electric insulation between the first touch electrodes 172 and the second touch electrodes 173 is achieved by the second passivation layer 174. Alternatively, the first touch electrodes 172 and the second touch electrodes 173 may be located on the same layer, referring to FIG. 1D which shows a schematic cross-sectional diagram of a touch structure in FIG. 1B taken along a direction of A1-A2. Being different from FIG. 1C, FIG. 1D shows that the first touch electrodes 172 and the second touch electrodes 173 are located on the same layer, that is, the touch layers respectively formed by the first touch electrodes 172 and the second touch electrodes 173 are also located on the same layer, where the first touch electrodes 172 cross the second touch electrodes 173 by bridges 175 at the intersections between the first touch electrodes 172 and the second touch electrodes 173.

As for the structure of the AMOLED display panel shown in FIG. 1A, electromagnetic interference occurs between the touch structure 17 and the cathodic electrode 15 during operation of the AMOLED display panel, so that the display effect and the touch control effect of the AMOLED display panel are affected; in addition, regardless of the structure shown in FIG. 1C or 1D, the touch structure 17 is generally formed by a photolithographic process. In manufacturing the structures shown in FIGS. 1C and 1D, processes of film forming, adhesive applying, exposing, developing, etching and stripping are conducted for four times, resulting in lots of manufacturing processes; moreover, one photo mask is needed for each manufacturing process, resulting in a high production cost.

In view of the above, solutions are provided by embodiments of the present disclosure. A touch panel is provided according to embodiments of the present disclosure, and FIG. 2 is a schematic diagram showing the structure of the touch panel according to embodiments of the present disclosure. Referring to FIG. 2, the touch panel includes: a first substrate 21 and a second substrate 22 disposed opposite to each other; an organic light emitting layer 23 which is located between the first substrate 21 and the second substrate 22 and includes at least a cathodic layer formed by a plurality of strip-shaped cathodic electrodes 232; and a first touch layer 241 which is located between the first substrate 21 and the second substrate 22 and includes a plurality of first touch electrodes (not shown in FIG. 2), and the first touch electrode includes at least one first touch sub-electrode 24, a projection of which on the organic light emitting layer 23 in a direction perpendicular to the organic light emitting layer 23 is located between two adjacent cathodic electrodes 232. It should be noted that the projection prefers to the projection in the perpendicular direction, i.e. the projection in a direction perpendicular to the display panel. By at least disposing the first touch layer for the touch control function between the first substrate and the second substrate, forming the cathodic electrode 232 into a strip shape, and disposing the projection, on the organic light emitting layer 23, of the first touch sub-electrode 24 in the first touch layer in the direction perpendicular to the organic light emitting layer 23 between two adjacent cathodic electrodes 232, the cathodic layer is staggered relative to the first touch layer, therefore a coupled parasitic capacitance formed between the cathodic layer and the first touch layer may be eliminated, and electromagnetic interference between the first touch layer and the cathodic electrode 232 may be reduced compared to the related art, so that the display effect and the touch control effect may be improved. In addition, both the first touch layer and the organic light emitting layer 23 may be formed by an evaporation process since the organic light emitting layer 23 is also disposed between the first substrate 21 and the second substrate 22, therefore manufacturing processes may be reduced compared to the photolithographic process of forming the first touch layer and the organic light emitting layer 23 in the related art; moreover, the production cost may be reduced by using an evaporation mask in the manufacturing processes compared to the photo mask used in the related art.

In some embodiments, the organic light emitting layer 23 further includes: a pixel layer 2311 and a cathode protection layer 233, where the pixel layer is located between the cathodic layer and the second substrate 22 and includes a plurality of pixels 231 below the cathodic electrodes 232, and the cathode protection layer 233 has a planar shape and is located on the cathodic layer. It should be noted that an upward direction refers to a direction from the second substrate 22 to the organic light emitting layer 23, and a downward direction refers to a direction opposite to the upward direction, where terms such as “on” and “below” describe relative orientation of items which may be in direct contact or indirect contact.

Further, the touch panel further includes a second touch layer including a plurality of second touch electrodes, and the second touch layer and the first touch layer are correspondingly disposed to implement the touch control function of the touch panel. The second touch layer may be located at different locations which are shown below for example in embodiments of the present disclosure.

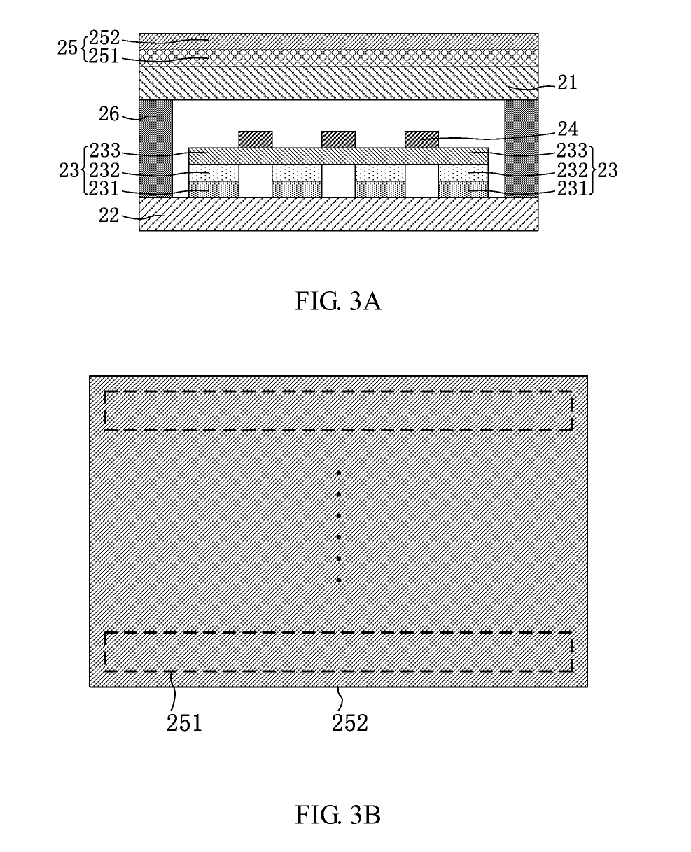

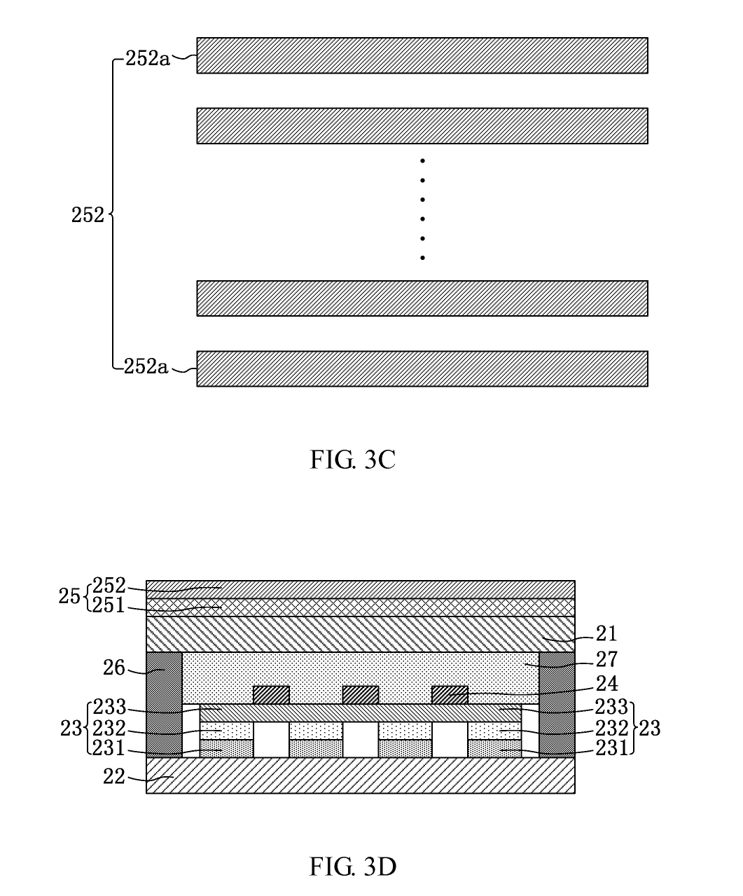

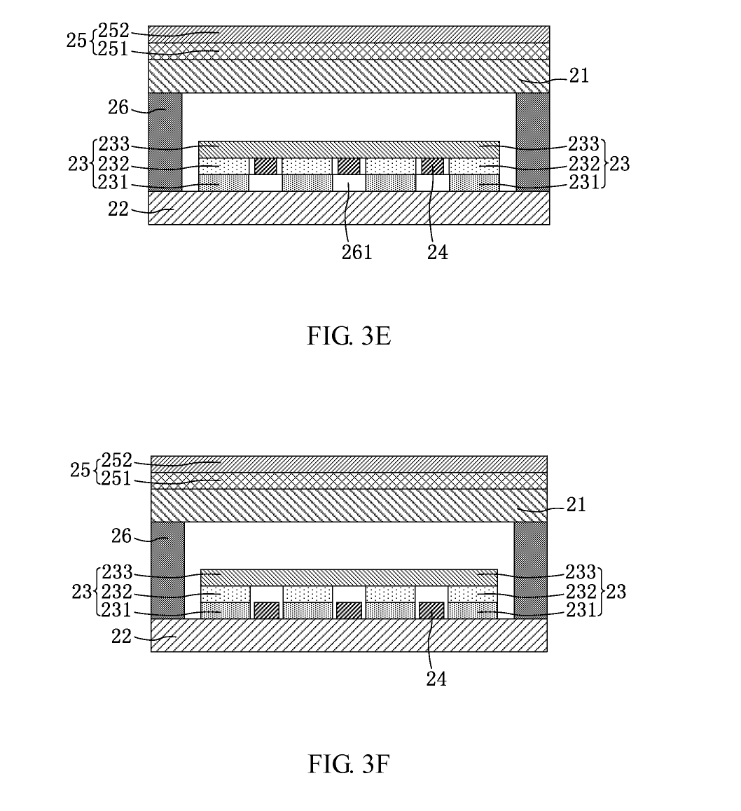

The second touch layer may be located at an outward side of the first substrate. Referring to FIG. 3A, a second touch layer 25 is located on a surface of the first substrate 21 which is away from the second substrate 22, and the second touch layer 25 further includes a first passivation layer 252 on a second touch electrode 251. Moreover, the first substrate 21 provided with the second touch layer 25 may be adhered together with the second substrate 22 provided with the organic light emitting layer 23 and the first touch layer through frame adhesives 26.

The first passivation layer 252 of the second touch layer 25 in FIG. 3A may be an integral structure in a planar shape, as shown in for example FIG. 3B. As shown in FIG. 3B, the first passivation layer 252 in a planar shape is located on the second touch electrode 251, and this is only one example of the structure of the first passivation layer 252. In another example, referring to FIG. 3C, the first passivation layer 252 may further include a plurality of first passivation units 252a on the second touch electrodes 251. Compared to the structure shown in FIG. 3A, the second touch electrode 251 and the first passivation unit 252a shown in FIG. 3C may be formed by adopting the same photo mask to perform lithography, thus further reducing not only manufacturing processes but also production cost.

Further, referring to FIG. 3D, the touch panel shown in FIG. 3A may further include a first dielectric layer 27, which is filled between the first touch layer formed by the first touch sub-electrodes 24 and the first substrate 21. By filling the first dielectric layer 27, thickness of a box formed by aligning and adhering the first substrate 21 to the second substrate 22 is well controlled, and the organic light emitting layer 23 is better protected. In addition, since a dielectric constant of the first dielectric layer 27 is greater than that of air, the touch control effect of the touch panel may be further improved.

In all the above embodiments, each of the first touch sub-electrodes 24 of the first touch layer is located on the cathode protection layer 233, a perpendicular projection of the first touch sub-electrode 24 on the organic light emitting layer 23 is located between two adjacent cathodic electrodes 232, and the first touch sub-electrode 24 is electrically insulated from the cathodic electrode 232 through the cathode protection layer 233. Besides the above configuration of the first touch layer, the first touch layer may be alternatively disposed on other films of the organic light emitting layer. For example, referring to FIG. 3E, the first touch sub-electrodes 24 forming the first touch layer are located on the same layer with the cathodic electrodes 232, the first touch sub-electrode 24 is located between two adjacent cathodic electrodes 232 and located on an organic film 261 between two adjacent pixels 231, and the first touch sub-electrode 24 is electrically insulated from the cathodic electrode 232. Or referring to FIG. 3F, the first touch sub-electrodes 24 forming the first touch layer are located on the same layer with the pixels 231, and the first touch sub-electrodes 24 and the pixels 231 are all located on the second substrate 22, where the first touch sub-electrode 24 is located between two adjacent pixels 231. In addition, in the touch panel shown in FIGS. 3E and 3F, the first dielectric layer may also be filled between the cathode protection layer 233 and the first substrate 21, like the structure of the touch panel shown in FIG. 3D, which is not described again here.

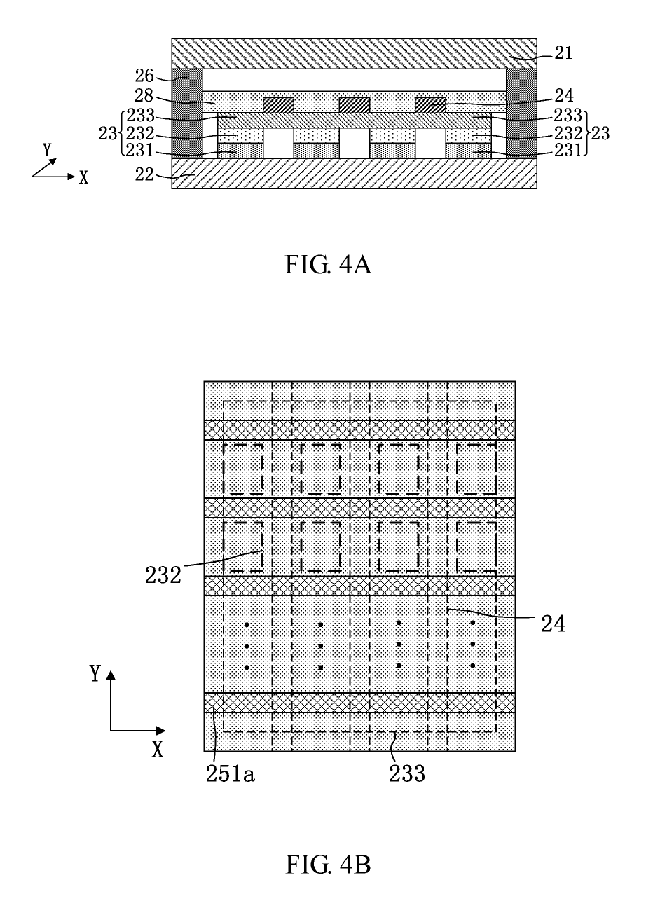

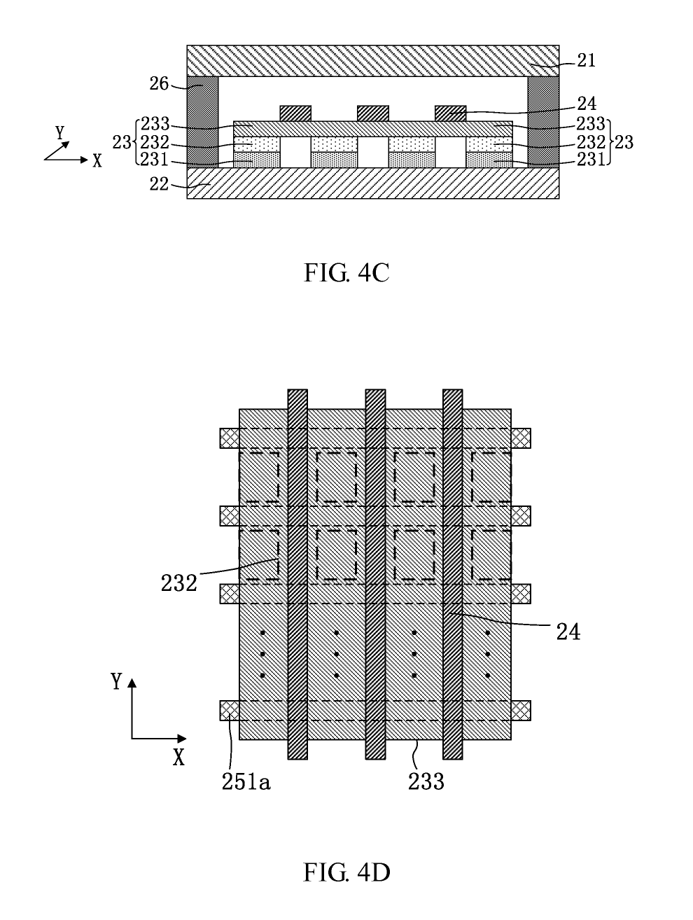

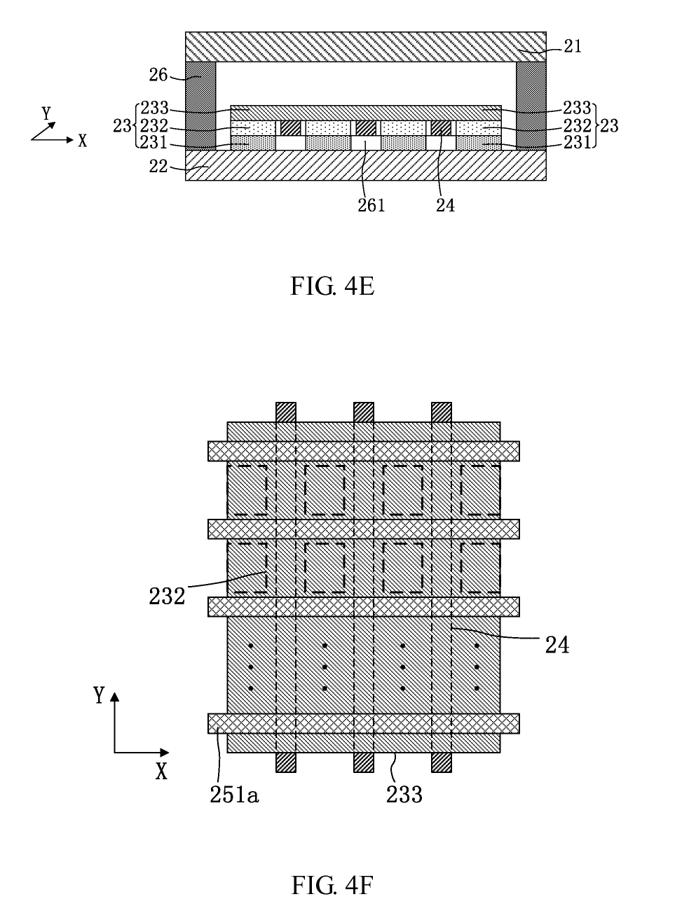

Besides the above embodiments in which the second touch layer is located at the outward side of the first substrate, the second touch layer may be alternatively located between the first substrate and the second substrate. As shown in FIG. 4A, the first touch sub-electrodes 24 forming the first touch layer are located on the cathode protection layer 233 of the organic light emitting layer 23, a perpendicular projection of the first touch sub-electrode 24 on the organic light emitting layer 23 is located between two adjacent cathodic electrodes 232 arranged along a direction X, and the first touch sub-electrode 24 is electrically insulated from the cathodic electrode 232 through the cathode protection layer 233. FIG. 4B is a top view of the first touch layer, the second touch layer and the organic light emitting layer in FIG. 4A. As shown in FIG. 4B, the second touch electrode (not shown in FIG. 4B) includes at least one second touch sub-electrode 251a, and a plurality of second touch electrodes form the second touch layer (not shown in FIG. 4B), where the second touch sub-electrode 251a is located on the first touch layer and between the first substrate 21 and the second substrate 22, and is electrically insulated from the first touch layer through a first insulating layer 28, and a perpendicular projection of the second touch sub-electrode 251a on the organic light emitting layer 23 is located between two adjacent cathodic electrodes 232 arranged along a direction Y. By disposing the second touch layer between the first substrate and the second substrate, disposing the second touch layer and the first touch layer in different layers, and disposing the perpendicular projection, on the organic light emitting layer 23, of the second touch sub-electrode 251a in the second touch layer between two adjacent cathodic electrodes 232 arranged along the direction Y, a cathodic layer is staggered relative to the second touch layer, therefore a coupled parasitic capacitance formed between the cathodic layer and the first touch layer may be eliminated and, compared to the related art, electromagnetic interference between the second touch layer and the cathodic electrode 232 may be reduced, so that the display effect and the touch control effect may be further improved. In addition, both the second touch layer and the organic light emitting layer may be formed by an evaporation process by using an evaporation mask, therefore manufacturing processes and production cost may be further reduced compared to forming the second touch layer by using a photo mask.

The structure shown in FIGS. 4A and 4B is an example in which the second touch layer 25 is located between the first substrate 21 and the second substrate 22, and the second touch layer 25 and the first touch layer are located on different layers. In other examples, the first touch layer and the second touch layer may also be located at any location between the first substrate and the second substrate as long as the first touch layer and the second touch layer are not located on the same layer. for example, as shown in FIG. 4C, the first touch sub-electrode 24 forming the first touch layer is located on the cathode protection layer 233 of the organic light emitting layer 23, a projection of the first touch sub-electrode 24 on the organic light emitting layer 23 is located between two adjacent cathodic electrodes 232 arranged along a direction X, and the first touch sub-electrode 24 is electrically insulated from the cathodic electrode 232 through the cathode protection layer 233. FIG. 4D is a top view of a first touch layer, a second touch layer and an organic light emitting layer in FIG. 4C, as shown in FIG. 4D, a second touch electrode (not shown in FIG. 4D) includes at least one second touch sub-electrode 251a, and a plurality of second touch electrodes form a second touch layer (not shown in FIG. 4D), where the second touch sub-electrode 251a is located on the second substrate 22 and located on the same layer with pixels 231 of the organic light emitting layer 23, a projection of the second touch sub-electrode 251a on the organic light emitting layer 23 is located between two adjacent cathodic electrodes 232 arranged along a direction of Y. Or as shown in FIG. 4E, the first touch sub-electrode 24 forming the first touch layer is located on the same layer with the cathodic electrodes 232, the first touch sub-electrode 24 is located between two adjacent cathodic electrodes 232 arranged along a direction X and located on an organic film 261 between two adjacent pixels 231, and the first touch sub-electrode 24 is electrically insulated from the cathodic electrode 232. FIG. 4F is a top view of a first touch layer, a second touch layer and an organic light emitting layer in FIG. 4E, as shown in FIG. 4F, a second touch electrode (not shown in FIG. 4F) includes at least one second touch sub-electrode 251a, and a plurality of second touch electrodes form a second touch layer (not shown in FIG. 4F), where the second touch sub-electrode 251a is located on the cathodic electrode 232, a projection of the second touch sub-electrode 251a on the organic light emitting layer 23 is located between two adjacent cathodic electrodes 232 arranged along a direction of Y, and the second touch sub-electrode 251a is electrically insulated from the first touch sub-electrode 24 and the cathodic electrode 232 through the cathode protection layer 233.

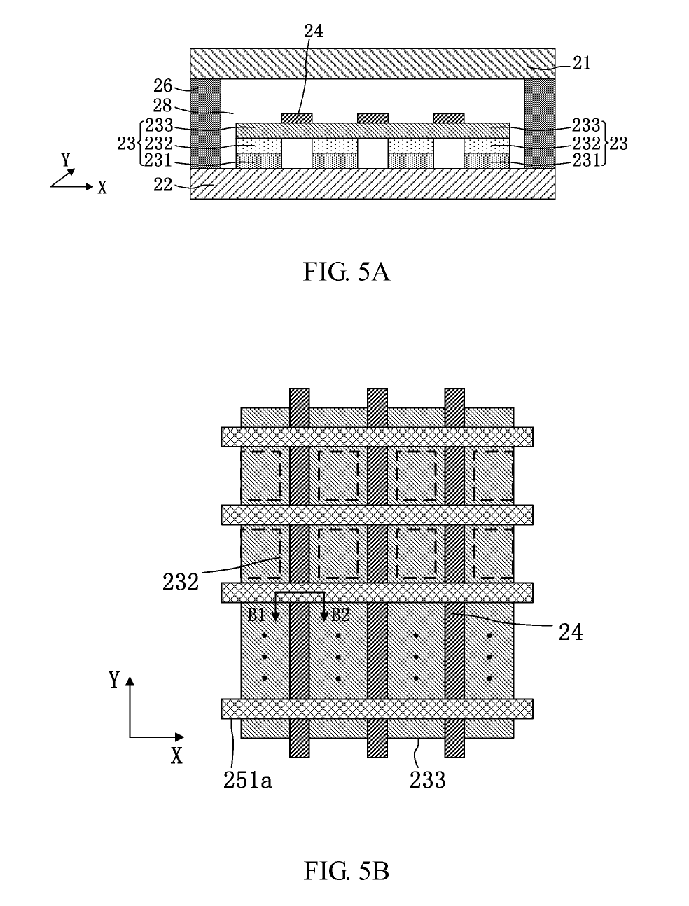

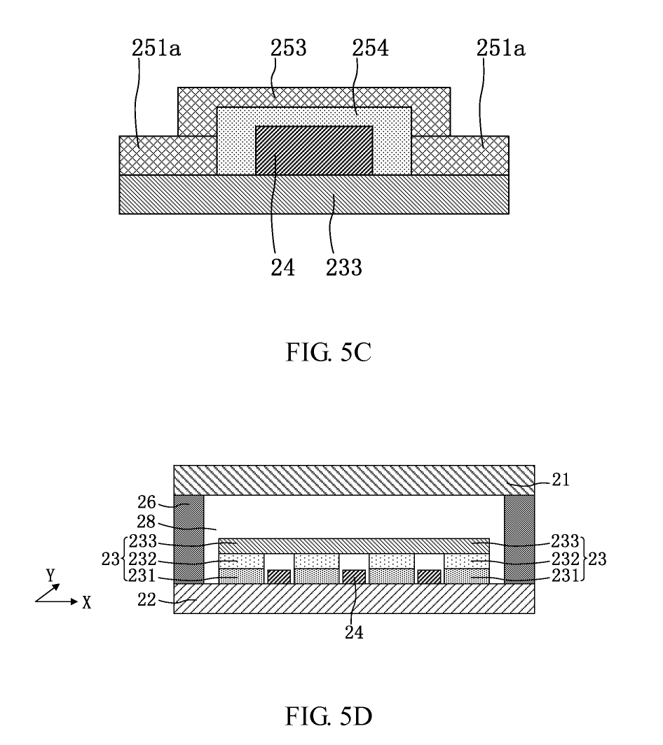

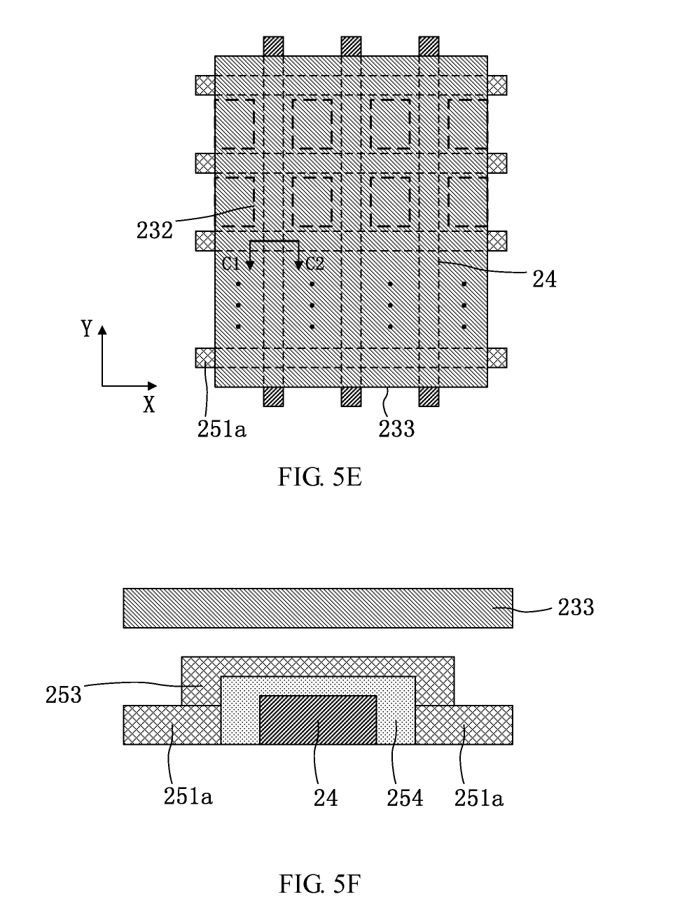

Besides the case that the second touch layer and the first touch layer are located on different layers, the second touch layer and the first touch layer may also be located on the same layer. As shown in FIG. 5A, the first touch sub-electrode 24 forming the first touch layer is located on the cathode protection layer 233 of the organic light emitting layer 23, and a projection of the first touch sub-electrode 24 on the organic light emitting layer 23 is located between two adjacent cathodic electrodes 232 arranged along a direction X. FIG. 5B is a top view of a first touch layer, a second touch layer and an organic light emitting layer in FIG. 5A, as shown in FIG. 5B, a second touch electrode (not shown in FIG. 5B) includes at least one second touch sub-electrode 251a, and a plurality of second touch electrodes form a second touch layer (not shown in FIG. 5B), where the second touch sub-electrode 251a and the first touch sub-electrode 24 are located on the same layer and both located on the cathode protection layer 233 of the organic light emitting layer 23, and a projection of the second touch sub-electrode 251a on the organic light emitting layer 23 is located between two adjacent cathodic electrodes 232 arranged along a direction of Y. FIG. 5C is a schematic cross-sectional diagram of the first touch layer, the second touch layer and the organic light emitting layer in FIG. 5B taken along a direction of B1-B2, as shown in FIG. 5C, since the first touch sub-electrode 24 crosses the second touch sub-electrode 251a and is located in the same layer with the second touch sub-electrode 251a, each second touch sub-electrode 251a would be divided into a plurality of segments and the segments of each second touch sub-electrode 251a are electrically connected through bridges 253, and the second touch sub-electrode 251a is electrically insulated from the first touch sub-electrode 24 through a second insulating layer 254. By disposing the second touch layer between the first substrate and the second substrate, disposing the second touch layer and the first touch layer in the same layer, and disposing the projection, on the organic light emitting layer 23, of the second touch sub-electrode 251a on the second touch layer between two adjacent cathodic electrodes 232 arranged along a direction of Y, a cathodic layer is staggered relative to the second touch layer, therefore a coupled parasitic capacitance formed between the cathodic layer and the first touch layer may be eliminated and, compared to the related art, electromagnetic interference between the second touch layer and the cathodic electrode 232 may be reduced, so that display effect and touch control effect may be further improved. In addition, the second touch layer and the organic light emitting layer may be formed by an evaporation mask to perform evaporating, therefore manufacturing processes and production cost may be further reduced compared to forming the second touch layer by using a photo mask.

The structure shown in FIGS. 5A to 5C is one example in which the second touch layer 25 is located between the first substrate 21 and the second substrate 22, and the second touch layer 25 and the first touch layer are located on the same layer. In another example, as shown in FIG. 5D, the first touch sub-electrode 24 forming the first touch layer is located on the second substrate 22 and located on the same layer with pixels 231 of the organic light emitting layer 23, and a projection of the first touch sub-electrode 24 on the organic light emitting layer 23 is located between two adjacent cathodic electrodes 232 arranged along a direction X. FIG. 5E is a top view of a first touch layer, a second touch layer and an organic light emitting layer in FIG. 5D, as shown in FIG. 5E, a second touch electrode (not shown in FIG. 5E) includes at least one second touch sub-electrode 251a, and a plurality of second touch electrodes form a second touch layer (not shown in FIG. 5E), where the second touch sub-electrode 251a is located on the same layer with pixels 231 of the organic light emitting layer 23, i.e. the second touch sub-electrode 251a and the first touch sub-electrode 24 are located on the same layer, and a projection of the second touch sub-electrode 251a on the organic light emitting layer 23 is located between two adjacent cathodic electrodes 232 arranged along a direction of Y. FIG. 5F is a schematic cross-sectional diagram of the first touch layer, the second touch layer and the organic light emitting layer in FIG. 5E taken along a direction of C1-C2, as shown in FIG. 5F, since the first touch sub-electrode 24 crosses the second touch sub-electrode 251a and is located in the same layer with the second touch sub-electrode 251a, each second touch sub-electrode 251a would be divided into a plurality of segments and the segments of each second touch sub-electrode 251a are electrically connected through bridges 253, and the second touch sub-electrode 251a is electrically insulated from the first touch sub-electrode 24 through a second insulating layer 254.

In the above embodiments, the first substrate 21 may be formed of Cover Lens or Cover Glass, and the second substrate 22 may be an array substrate.

In the above embodiments, metal material or transparent conductive material may be preferred to be adopted for the first touch electrode on the first touch layer and the second touch electrode on the second touch layer, where the transparent conductive material may be any one of or a combination of Indium Tin Oxide (ITO), Indium Zinc Oxide (IZO) or Indium Gallium Zinc Oxide (IGZO). Further, material of the first touch electrode on the first touch layer can be metal material. Since line resistance of metal manufactured by adopting an evaporation process is less than that of the transparent conductive material, the first touch layer manufactured by metal material makes better touch control effect.

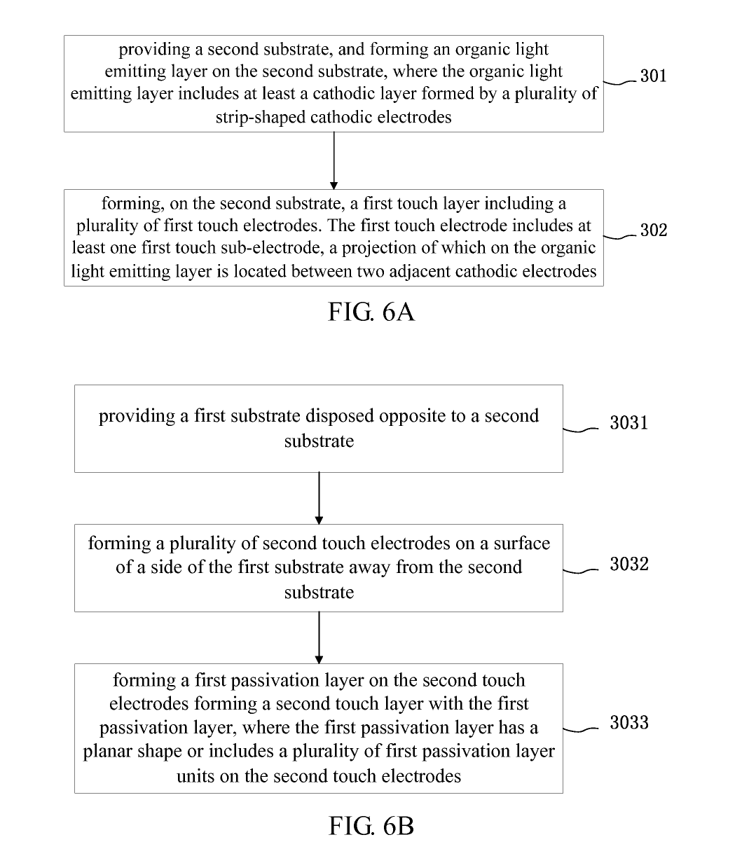

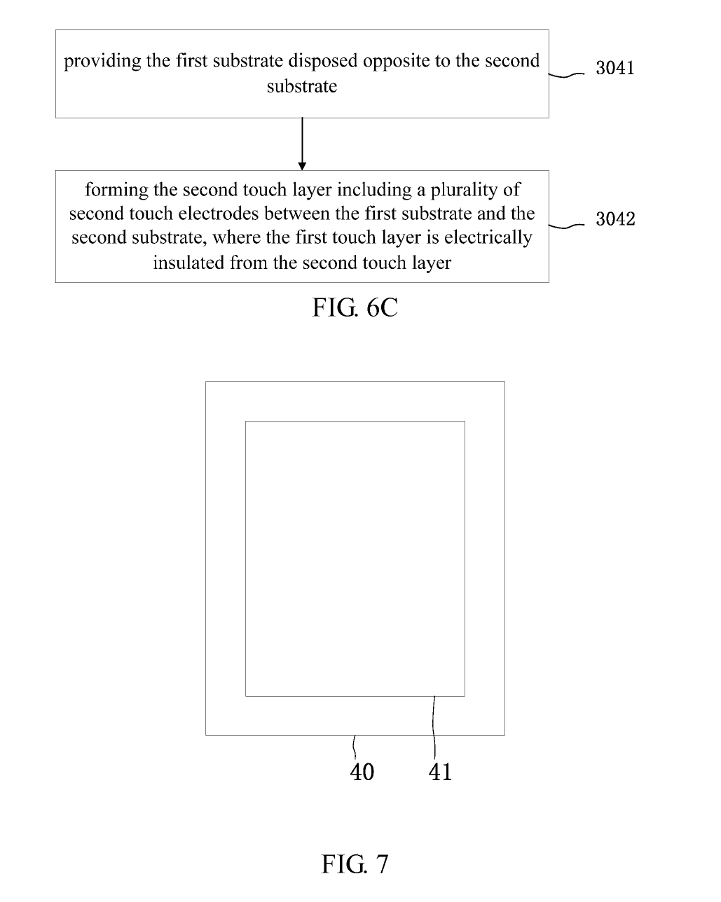

A manufacturing method of a touch panel is further provided according to embodiments of the present disclosure. FIG. 6A is a schematic flow diagram of a manufacturing method of a touch panel provided by embodiments of the present disclosure. Referring to FIG. 6A, the manufacturing method of the touch panel includes following steps.

Step 301: providing a second substrate, and forming an organic light emitting layer on the second substrate, where the organic light emitting layer includes at least a cathodic layer formed by a plurality of strip-shaped cathodic electrodes; Step 302: forming, on the second substrate, a first touch layer including a plurality of first touch electrodes. The first touch electrode includes at least one first touch sub-electrode, a projection of which on the organic light emitting layer is located between two adjacent cathodic electrodes.

Further, in some embodiments, the organic light emitting layer further includes: a pixel layer and a cathode protection layer. The pixel layer is formed between the cathodic layer and the second substrate and includes a plurality of pixels located below the cathodic electrodes, and the cathode protection layer has a planar shape and is formed on the cathodic layer.

In some embodiments, both the organic light emitting layer and the first touch layer are preferred to be formed by fine metal mask. Manufacturing processes and production cost may be reduced by technical solutions of the present disclosure compared to the first touch layer in the related art which is needed to be formed by adopting a photo mask and a photolithographic process.

It should be noted that the touch panel may further include a first substrate and a second touch layer besides a structure manufactured through above steps, and the second touch layer may be located on one side of the first substrate or between the first substrate and the second substrate as long as a touch control function can be achieved by the second touch layer and the first touch layer. Embodiments of a manufacturing method of the second touch layer are provided below on the base of FIG. 6A.

In some embodiments, referring to FIG. 6A, the manufacturing method of the second touch layer in a touch panel may include following steps.

Step 3031: providing a first substrate disposed opposite to a second substrate; step 3032: forming a plurality of second touch electrodes on a surface of a side of the first substrate away from the second substrate; step 3033: forming a first passivation layer on the second touch electrodes forming a second touch layer with the first passivation layer, where the first passivation layer has a planar shape or includes a plurality of first passivation units on the second touch electrodes.

To enable better control to thickness of a box during box aligning and adhering of the first substrate and the second substrate, play a better protection role for the organic light emitting layer, and further improve touch control effect of the touch panel, the manufacturing method of the touch panel may further include: forming a first dielectric layer between the first touch layer and the first substrate.

By steps 3031 to 3033, the second touch layer is manufactured on a surface of a side of the first substrate away from the second substrate. In addition, the second touch layer may also be manufactured between the first substrate and the second substrate. Referring to FIG. 6C, a manufacturing method, in which the second touch layer may also be disposed between the two substrates, of the touch panel may include following steps.

Step 3041: providing the first substrate disposed opposite to the second substrate; step 3042: forming the second touch layer including a plurality of second touch electrodes between the first substrate and the second substrate, where the first touch layer is electrically insulated from the second touch layer.

Further, the second touch electrode includes at least one second touch sub-electrode, a projection of which on the organic light emitting layer is located between two adjacent cathodic electrodes.

A display device is further provided by embodiments of the present disclosure. FIG. 7 is a schematic diagram showing the structure of a display device provided by embodiments of the present disclosure, referring to FIG. 7, a display device 40 includes a touch panel 41, and may further include a driving circuit and other components supporting the display device 40 to operate normally. The touch panel 41 is a touch panel described in above embodiments. The display device 40 may be one of a mobile phone, a tablet computer, an electronic paper and a digital photo frame.

As for the touch panel, manufacturing method thereof and display device provided by embodiments of the present disclosure, by at least disposing the first touch layer achieving touch control function between the first substrate and the second substrate, disposing the cathodic electrode into a strip shape, and disposing the projection, on the organic light emitting layer, of the first touch sub-electrode on the first touch layer between two adjacent cathodic electrodes, at least electromagnetic interference between the first touch layer and the cathodic electrode can be reduced, so that display effect and touch control effect may be improved. In addition, the first touch layer and the organic light emitting layer may be formed by an evaporation process since the organic light emitting layer is also disposed between the first substrate and the second substrate, thus reducing not only manufacturing processes but also production cost.

Note that the above are only some embodiments and adopted technical principles of the present disclosure. It can be understand by those skilled in the art that the present disclosure is not limited to the specific embodiments described here, and various apparent modification, readjustment and replacement can be performed for those skilled in the art without depart from the protection scope of the present disclosure. Therefore, though the present disclosure is described in detail through above embodiments, the present disclosure is not limited to the above embodiments, other more equivalent embodiments may be further included without depart from the conception of the present disclosure, and the scope of the present disclosure is determined by the scope of attached claims.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A touch panel, comprising:
a first substrate and a second substrate disposed opposite to each other;
an organic light emitting layer located between the first substrate and the second substrate, wherein the organic light emitting layer comprises at least a cathodic layer formed by a plurality of strip-shaped cathodic electrodes; and
a first touch layer, which is located between the first substrate and the second substrate and comprises a plurality of first touch electrodes, each of the first touch electrodes comprises at least one first touch sub-electrode, a projection of the first touch sub-electrode on the organic light emitting layer is located between two adjacent cathodic electrodes.

2. The touch panel according to claim 1, wherein the touch panel further comprises a second touch layer comprising a plurality of second touch electrodes, and the second touch layer and the first touch layer are correspondingly disposed to implement a touch control function of the touch panel.

3. The touch panel according to claim 2, wherein the second touch layer is located on a surface of the first substrate that is away from the second substrate.

4. The touch panel according to claim 3, wherein the second touch layer further comprises a first passivation layer on the second touch electrodes; and
the first passivation layer has a planar shape, or the first passivation layer comprises a plurality of first passivation units on the second touch electrodes.

5. The touch panel according to claim 3, wherein the touch panel further comprises a first dielectric layer filled between the first touch layer and the first substrate.

6. The touch panel according to claim 2, wherein the second touch layer is located between the first substrate and the second substrate, and the second touch layer and the first touch layer are located on different layers and are electrically insulated from each other; and
at least one of the second touch electrodes comprises at least one second touch sub-electrode, a projection of which on the organic light emitting layer is located between the two adjacent cathodic electrodes.

7. The touch panel according to claim 2, wherein the second touch layer and the first touch layer are located on the same layer and are electrically insulated from each other; and
at least one of the second touch electrodes comprises at least one second touch sub-electrode, each of the at least one second touch sub-electrode is divided into a plurality of segments which are electrically connected through bridges, and a projection of the second touch sub-electrode on the organic light emitting layer is located between the two adjacent cathodic electrodes.

8. The touch panel according to claim 1, wherein the organic light emitting layer further comprises: a pixel layer and a cathode protection layer, and the pixel layer is located between the cathodic layer and the second substrate;
the pixel layer further comprises a plurality of pixels located below the cathodic electrodes; and
the cathode protection layer has a planar shape and is located on the cathodic layer.

9. A display device, comprising a touch panel according to claim 1.

10. A manufacturing method of a touch panel, comprising:
forming an organic light emitting layer on a second substrate, wherein the organic light emitting layer comprises at least a cathodic layer formed by a plurality of strip-shaped cathodic electrodes; and
forming, on the second substrate, a first touch layer comprising a plurality of first touch electrodes; wherein at least one of the first touch electrodes comprises at least one first touch sub-electrode, a projection of which on the organic light emitting layer is located between two adjacent cathodic electrodes.

11. The manufacturing method of the touch panel according to claim 10, further comprising:
providing a first substrate disposed opposite to the second substrate;
forming a plurality of second touch electrodes on a surface of the first substrate that is away from the second substrate; and
forming a first passivation layer on the second touch electrodes, wherein the second touch electrodes and the first passivation layer form a second touch layer, and the first passivation layer has a planar shape or comprises a plurality of first passivation units on the second touch electrodes.

12. The manufacturing method of the touch panel according to claim 11, further comprising:
forming a first dielectric layer between the first touch layer and the first substrate.

13. The manufacturing method of the touch panel according to claim 10, wherein the organic light emitting layer further comprises a pixel layer and a cathode protection layer, the pixel layer is formed between the cathodic layer and the second substrate and comprises a plurality of pixels located below the cathodic electrodes, and the cathode protection layer has a planar shape and is formed on the cathodic layer.

14. The manufacturing method of the touch panel according to claim 10, further comprising:
providing a first substrate disposed opposite to the second substrate; and
forming a second touch layer comprising a plurality of second touch electrodes between the first substrate and the second substrate, wherein the first touch layer is electrically insulated from the second touch layer.

15. The manufacturing method of the touch panel according to claim 14, wherein at least one of the second touch electrodes comprises at least one second touch sub-electrode, a projection of which on the organic light emitting layer is located between the two adjacent cathodic electrodes.
